(19) United States
(12) Patent Application Publication
(10) Pub. No.: US 2008/0063121 A1
(43) Pub. Date: Mar. 13, 2008

(54) Method for Estimating the Phase and the Gain of Observation Data Transmitted Over a Qam-Modulated Transmission Channel

(76) Inventors: Benoit Geller, Paris (FR); Jean-Pierre Barbot, Issy-Les-Moulineaux (FR); Jean-Marc Brossier, Le Champ-Pres-Froges (FR); Christophe Vanstraceele, Cachan (FR)

Correspondence Address: YOUNG & THOMPSON, 745 SOUTH 23RD STREET, 2ND FLOOR, ARLINGTON, VA, 22202, US

(21) Appl. No.: 11/663,275

(22) PCT Filed: Sep. 16, 2005
(86) PCT No.: PCT/FR05/02301

§ 371 Date: Oct. 17, 2007

(30) Foreign Application Priority Data
Sep. 20, 2004 (FR) 0409928

(51) Int. Cl. H04L 27/08

(52) U.S. Cl. 375/345

(57) ABSTRACT

The invention concerns a method for estimating the gain and/or the phase of observation data (yₖ) transmitted in QAM modulation. The method includes (A) iteratively estimating the phase and/or gain parameters based on a specific phase and/or gain law and (B) executing an adaptive procedure for estimating the phase and/or gain parameters, the adaptive procedure including at least one function for estimating the parameters based on the value of likelihood probability, expressed in terms of log-likelihood, of each observation data (yₖ) with respect to the set of bits constituting the symbols of the QAM modulation. The invention is applicable to single-carrier or multicarrier digital transmissions.

In present-day digital communications systems a digital signal which has to be transmitted is converted into a time-continuous analog signal which is then transmitted via a physical propagation medium, referred to as a transmission channel, such as a radio wave in air or a light wave in an optical fibre, for example. On receipt, the signal received, which undergoes physical interaction with the transmission channel, is processed and converted into digital form.

The stages used in emission normally comprise:
conversion of the set of binary values, bits, which is to be transmitted into a set of complex symbols belonging to a finite alphabet which can be represented in the form of a constellation in the complex plane,
conversion of the set of symbols into a baseband time-continuous waveform whose spectrum is centered around the frequency zero,
shifting by changing frequency, around a carrier frequency.

On receipt, paired operations are performed:
baseband return, by reverse shifting, using a complex demodulator,
conversion of the baseband time-continuous waveform into a set of complex values,
restoration of the binary values transmitted.

The operations of frequency shifting on emission, and baseband return on receipt are controlled by separate independent oscillators, one for transmitting, one for receiving. The frequencies and a fortiori the phases of these oscillators can therefore never perfectly coincide. In general there is a phase error, which varies over time.

Although the size of the abovementioned error can almost normally be compensated for using an analog device, such as a phase-locked loop applied to the frequency changing circuits, there is always a residue of baseband carrier frequency, and ultimately phase error, in the output from the complex demodulator.

The frequency or/and phase difference affecting the oscillators in transmission and reception constitutes a disturbing factor which introduces a parasitic out-of-phase error in the observations of the signal delivered at the output from the complex demodulator.

Other factors can help to intensify this parasitic out-of-phase error particularly the propagation time which the signal requires to pass through the transmission channel, and any relative movement between the transmitter and the receiver which gives rise to a Doppler effect, which also tends to introduce a disturbing out-of-phase error.

It would therefore seem essential to compensate for any phase drift so that the received signal can be suitably processed in order to extract and recognize the symbols transmitted with a satisfactory degree of certainty.

Phase drift compensation techniques known in the prior art are stated with reference to the baseband signal in relation to which the effect of the parasitic out-of-phase error θₖ applying to the observation data yₖ, which are complex data, delivered at the output from the complex demodulator in the receiver can be expressed using the relationship:
yₖ=aₖe^{iθk}+bₖ (1)

In this relationship, aₖ designates the complex symbol emitted, which belongs to the finite alphabet {Q1, Q2, . . . , QM} having M elements, in QAM modulation (Quadrature Amplitude Modulation), with M states, aₖε{Q1, Q2, . . . , Q_{M}}, M=2^{N}, N designating the length of the binary packets used to construct a complex symbol aₖ,
bₖ is an additional noise, which is assumed to be Gaussian, white, circular and centered.

Of the techniques known in the prior art which are used to allow estimation of the parasitic out-of-phase error θₖ with a view to correcting it, the most sophisticated estimates are based on extremely cumbersome digital processing, Monte Carlo methods using Markov chain or other methods, which simultaneously processes whole ranges of observation data received.

Such techniques have however proved to be very difficult if not impossible to implement in practice, because they require excessively great computing power in real time.

Because of their simplicity of use, the technique of phase locking loops, referred to as PLL, meaning Phase Locked Loop, which process observation data received sequentially in succession, are preferred.

Typically a phase locked loop is an iterative digital algorithm which makes it possible to estimate the phase value and therefore the parasitic out-of-phase error. The abovementioned digital algorithms and processing depend closely on the type of modulation used.

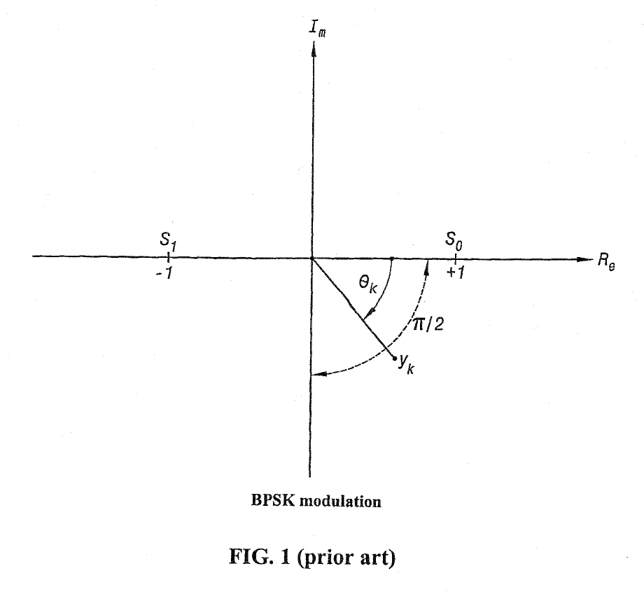

By way of example, in the case of two-state phase modulation, MDP2, also referred to as Binary Phase Shift Keying, BPSK, the symbols transmitted on transmission have the values −1 or +1. Because of the parasitic out-of-phase error θₖ mentioned above which is brought about by the transmission channel, the observation data obtained on reception as the output from the complex demodulator are no longer the corresponding −1 or +1 values, but these values out of phase, as shown in FIG. 1

A conventional phase locked loop which can be used to estimate the true phase and therefore the parasitic out-of-phase error θₖ in the case of BPSK modulation is the COSTAS loop, which can be used to estimate the phase φₖ of a current observation datum yₖ from the iterative formula
φₖ=φₖ₋₁+γIm(yₖ²e^{-i2φ}^{_{k−1}}) (2)
on the basis of the current observation datum yₖ and the previous estimate of the phase φₖ₋₁.

Other relationships are used for other types of modulation, in particular the modulation of two carriers in quadrature, referred to as QAM modulation, standing for Quadrature Amplitude Modulation.

In general, whatever type of modulation is used, phase locked loops fulfil the relationship:
φₖ=φₖ₋₁+γF(yₖ,φₖ₋₁) (3).

All phase locked loops of this type are designed to calculate the current phase φₖ as a function of the estimate of the previous phase φₖ₋₁ using a function F which depends closely on the type of M-QAM modulation in question.

Furthermore, parameter γ may be formed by a second order filtering function, a proportional and integral corrector, or by a higher order filtering function.

The aforesaid phase locked loops which adopt the traditional analog model have the same major limitation because of the fact that the phase estimate φₖ is essentially based on the preceding estimated value φₖ₋₁, on a function of one or several past observation data and/or the present observation datum and one or more past estimates.

Because of this, the current phase estimate and the correction of the current phase remain largely sub-optimal.

The restriction to a causal estimate, which only depends on past observations, is no longer necessary when a block of observation data are placed in memory, for example for the needs of error correction.

With this in mind patent application PCT WO 2004/036753 published on the 29 Apr. 2004 describes a process for estimating the phase of observation data transmitted via a transmission channel on the basis of BPSK or QAM modulated symbols, this operation being carried out on an observation data block by running at least one phase lock loop on a predetermined sequence of observation data extracted from that block.

The process described in this document effectively makes it possible to be substantially free of the abovementioned restriction to a causal estimate, because block-based processing makes it possible to take into account not only previous observation data but also subsequent observation data within the same block for the current evaluation of phase φₖ.

Thus, in an embodiment of the aforementioned process this restriction is overcome by using a first and then a second iterative process comprising a conventional phase loop, reading the observation data in one direction and then the reverse direction.

However, the aforesaid process has the disadvantage that it only makes use of information available in receivers which are equipped in particular with a turbo-decoder, in which information on the reliability of the observation data is also available, in the case of BPSK type modulation in which the symbol is equal to either +1 or −1.

This information is available in the form of soft information, a priori information on each symbol, in the turbo-decoder.

However, in this situation where the number of states in the matrix of symbols is restricted to two, the margin of error in the phase of each observation datum with respect to the aforesaid states and the corresponding symbols is close to ±Π/₂. The current phase loops in the state of the art used to detect observation data transmitted using BPSK modulation operate correctly and the introduction of an additional correction on the base of the aforesaid soft information in BPSK modulation definitely appears to be of reduced utility.

In particular, this invention has the object of providing a process of phase estimation for a digital receiver which is particularly suited to the processing of any digital signal transmitted through QAM modulation to a receiver equipped with a flexible error correction system, or, more generally, any receiver using an iterative method, known as a turbo method, such methods being conventionally used for error correction coding (turbo codes), equalization (turbo equalization) or synchronization (turbo synchronization).

Another object of this invention is also to provide a process for estimating gain for a digital receiver having automatic gain control which is particularly suitable for the processing of any digital signal transmitted by QAM modulation to a receiver provided with a soft error correction system, or more generally any receiver using an iterative method as mentioned in connection with the phase estimation process to which this invention relates.

Another object of this invention is also to provide a process for jointly estimating phase and gain for a digital receiver which is particularly suitable for the processing of any digital signal transmitted by QAM modulation to a receiver fitted with a soft error correction system, or more generally, any receiver using an iterative method such as mentioned in connection with the process for estimating phase or gain respectively to which this invention relates.

Another object of this invention is also implementation of the process of phase estimation and the process of gain estimation respectively in the joint process for estimating phase and gain to which this invention relates, in single carrier and/or multicarrier receivers.

Finally, another object of this invention is to implement a specific phase locked loop structure which makes it possible to increase the accuracy of the estimate of phase and gain respectively in the joint estimation of phase and gain in a digital receiver equipped with a soft error correction system, or, more generally, in any receiver using an equivalent iterative method.

The process of estimating phase and/or gain in observation data parameters placed in memory corresponding to a sequence of digital symbols formed by a suite of bits in QAM modulation transmitted by a transmission channel to which this invention relates is noteworthy in that it comprises the steps consisting of making a iterative estimate of these phase and/or gain parameters from a sequence of observation data, this iterative estimation being performed on the basis of a specific phase and/or gain relationship linking a successive estimated phase and/or gain observation data in this sequence, initializing at least one adaptive process of estimating the said phase and/or gain parameters on the basis of at least one of the successive phase and/or gain values estimated from these observation data and performing this adaptive estimation procedure comprising at least one function of estimating these phase and/or gain parameters on the basis of the likelihood probability value expressed in terms of the log-likelihood of each of the observation data in relation to the full set of bits constituting these symbols.

The process to which the invention relates finds application in the use of digital signal receivers having a decoding structure of the “turbo” type, in particular receivers for large flows of digital signals transmitted using QAM modulation with a large number of states.

It will be better understood from a reading of the description and examination of the drawings below, in which, with the exception of FIG. 1 relating to the prior art:

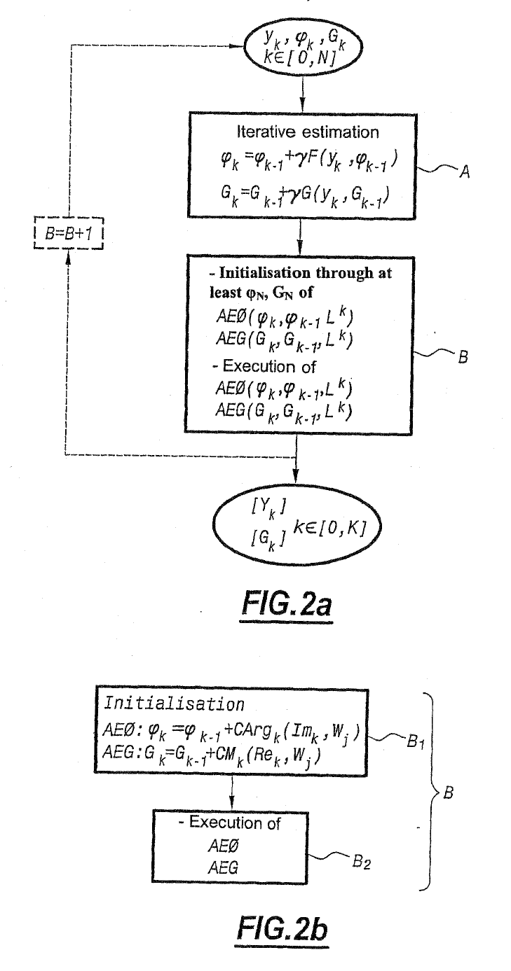

FIG. 2a shows by way of illustration a flow diagram of the essential stages in implementing the process to which this invention relates,

FIG. 2b shows by way of illustration a detail of implementation of the initialization stage followed by execution of the adaptive process executed by the process according to the invention as illustrated in FIG. 2a,

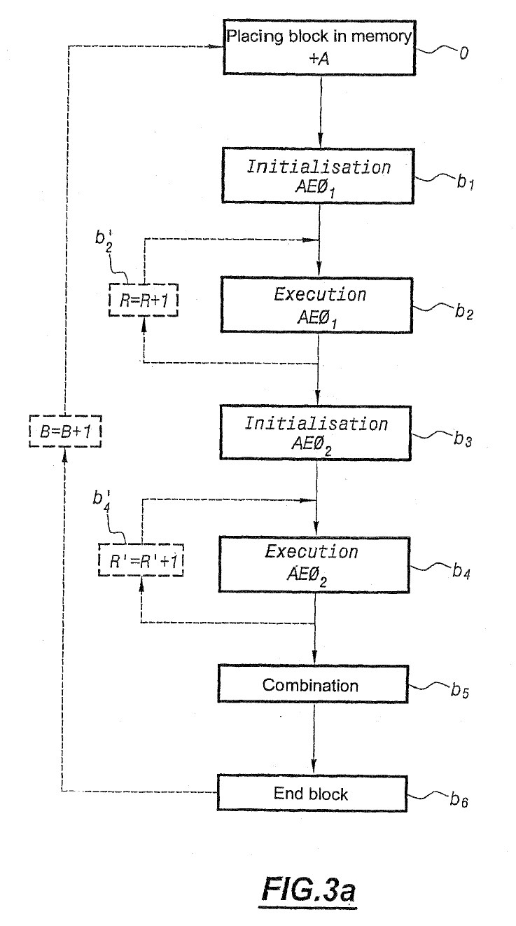

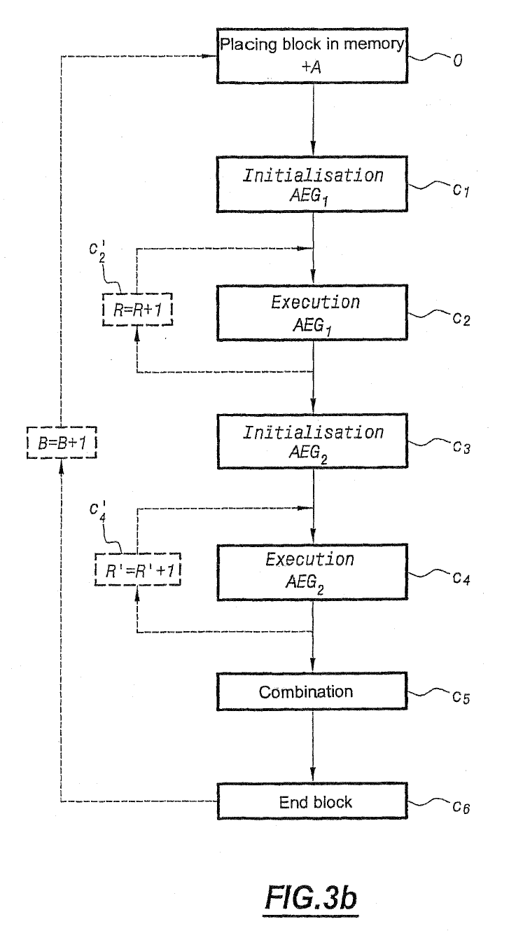

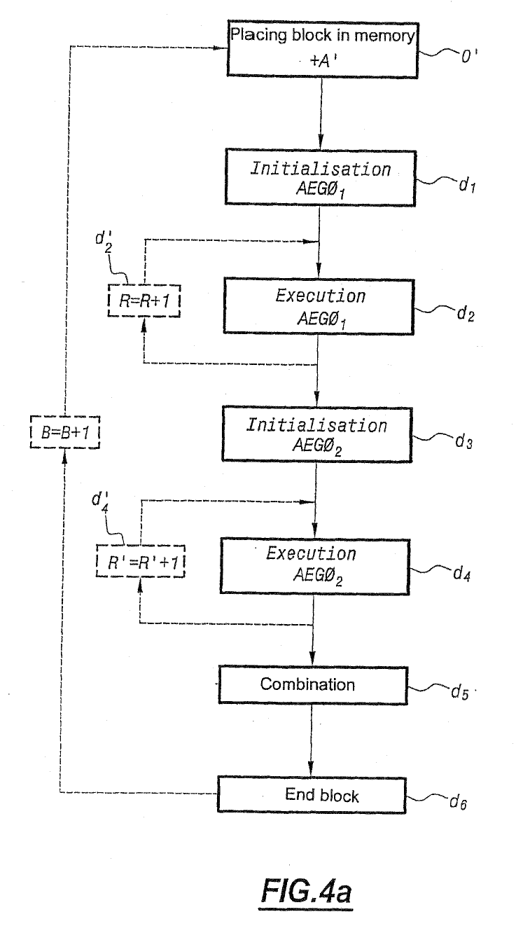

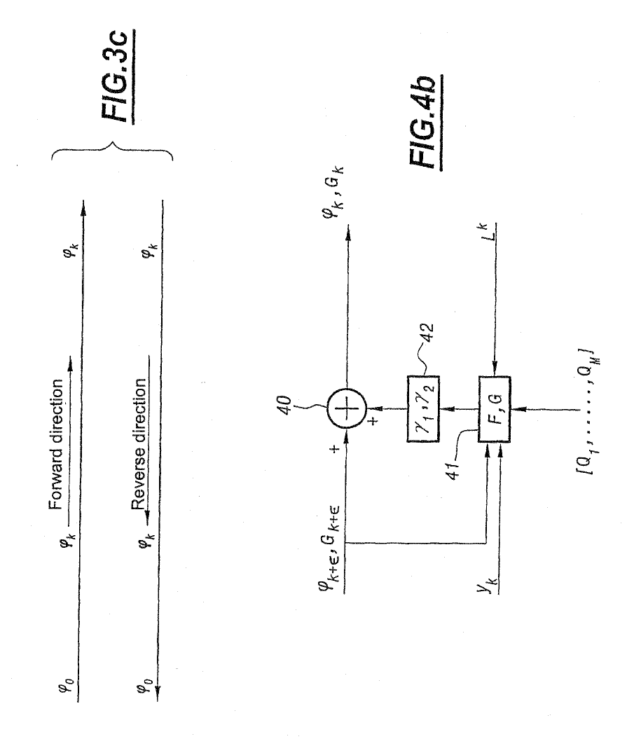

FIG. 3a shows by way of illustration a flow chart of the essential stages in implementing the process to which this invention relates in a first example relating to estimation of the phase,

FIG. 3b shows by way of illustration a flow chart of the essential stages in implementing the process to which this invention relates in a second example relating to the estimation of gain,

FIG. 3c shows by way of illustration a chronogram of the reading of observation data in a forward direction and a reverse direction respectively for executing implementation of the process according to the invention as illustrated in FIG. 3a or 3b,

FIG. 4a shows by way of illustration a flow chart of the essential stages in implementing the process according to the invention in a third preferred non-restrictive example relating to the joint estimation of gain and phase,

FIG. 4b shows a phase gain loop according to the object of this invention,

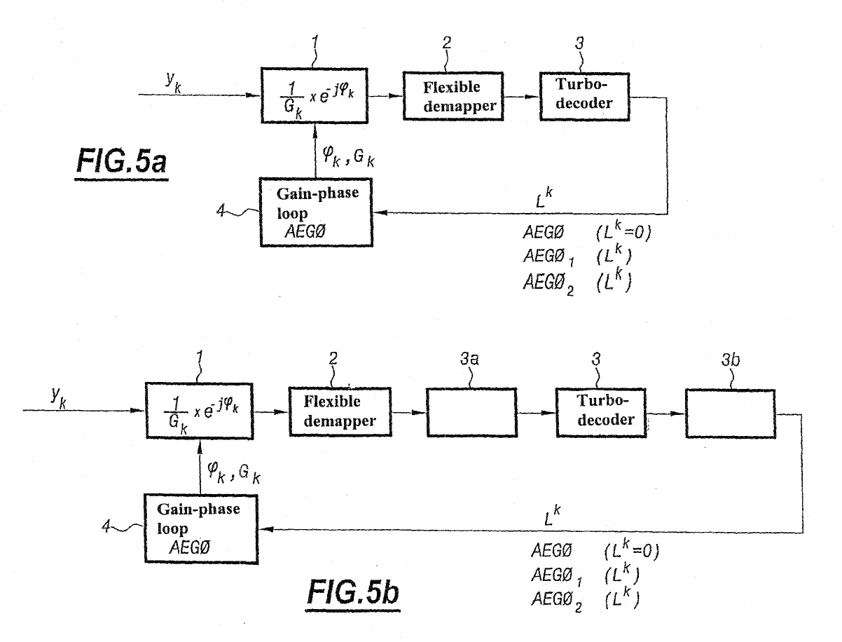

FIG. 5a shows in the form of functional blocks an illustrative diagram of a turbodecoding receiver equipped with a gain-phase loop according to the object of this invention implementing the process according to the invention illustrated in FIG. 4a,

FIG. 5b represents in the form of functional blocks a turbodecoding receiver which can perform phase disambiguation.

A more detailed description of implementation of the process according to this invention will now be provided in association with FIGS. 2a and 2b.

In general, it is pointed out that the process of estimating phase and/or gain parameters for observation data placed in memory to which this invention relates applies to data corresponding to a succession of digital symbols formed by a suite of bits in QAM modulation transmitted by any transmission channel

By “observation data placed in memory” is meant any suite of observation data yₖ placed in memory on any medium whatsoever.

In particular, and in a particularly advantageous embodiment of the process according to the invention, the latter may be implemented for observation data placed in memory as blocks and, in particular, observation data processed by a receiver equipped with turbo decoding facilities, as will be described later in the description.

In general, with reference to FIG. 2a, it is pointed out that the process according to the invention consists of, in a stage A, making an iterative estimate of the phase and/or gain parameters from a sequence of observation data selected from the observation data placed in memory.

The aforesaid iterative estimation is performed on the basis of a specific phase and/or gain relationship linking the estimated phase of successive observation data in the sequence selected.

Following iterative estimation stage A there is of course available a plurality of estimated phase and/or gain values resulting from stage A.

Stage A is then followed by a stage B which consists of initializing at least one adaptive process for estimating phase and/or gain parameters on the basis of at least one of the successive phase and/or gain values estimated from the observation data obtained in stage A.

Following the aforesaid initialization, the adaptive estimation process is then executed, and, in accordance with a particularly noteworthy aspect of the process to which this invention relates this comprises at least one function of estimating phase and/or gain parameters depending upon their likelihood probability values, expressed in terms of log-likelihood, for each observation datum with regard to the set of bits constituting the symbols in the modulation considered.

In general, and in the context of implementing the process according to this invention as illustrated in FIG. 2a, and in all the subsequent examples of implementation illustrated in the drawings and described below in the description, it is pointed out that:
a process is said to be iterative when the process is capable of evaluating, and in particular estimating, the value of a parameter for a current variable in relation to the value of that parameter for the same variable estimated at one or more preceding instants,
conversely, a process is said to be adaptive when the process is a process of evaluating, and in particular estimating, a parameter of a current variable having regard to an estimate or evaluation of the change in the value of that parameter in relation to for example an external physical law.

In the context of implementing the process according to this invention, it is pointed out that the iterative estimation implemented in stage A makes use of knowledge of the stored value of the phase or gain parameter respectively for at least the preceding observation datum in order to obtain a corresponding value of the phase or gain parameter respectively for the current observation datum yₖ of rank k.

Conversely, the adaptive process implemented in stage B uses not only the concept of the iterative nature of the value of the phase or gain parameter respectively, but an external variable, the external variable then corresponding to an estimate of the phase and/or gain parameters depending on the likelihood probability value obtained externally. This externally-obtained probability value may be provided by a turbo-decoder, for example, as will be described later in the description.

As far as the implementation of stage A in FIG. 2a is concerned, it is pointed out that the specific phase and/or gain law satisfies the relationship:
φₖ=φₖ₋₁+γF(yₖ,φₖ₋₁);Gₖ=Gₖ₋₁+γG(yₖ,Gₖ₋₁). (4)

In the above relationship:

φₖ, φₖ₋₁ indicate the value of the estimated phase of observation data yₖ and yₖ₋₁ respectively, of rank k and k−1 respectively,

Gₖ and Gₖ₋₁ indicate the estimated gain value for the observation data yₖ and yₖ₋₁ respectively, of rank k and k−1 respectively,

F and G respectively indicate a specific function which depends on the type of QAM modulation used,

γ indicates a predetermined filtering function.

Conversely, in stage B in FIG. 2a the adaptive process for estimating phase and/or gain parameters comprising at least one function of estimating the phase and/or gain parameters depending upon the likelihood probability value expressed in terms of the log-likelihood L^{k} for each observation datum in relation to the set of bits constituting the symbols for the QAM modulation in question is designated by:
AEφ(φₖ,φₖ₋₁,L^{k})
AEG(Gₖ,Gₖ₋₁,L^{k}),

With reference to the same FIG. 2a, it is pointed out that stage B is executed for a current block of data, for example B. After stage B has been executed, the process of estimating the phase and/or gain parameters for the observation data to which the invention relates of course consists of implementation for the next block of data, this operation being indicated in FIG. 2a by the return arrow shown as dotted, and proceeding to the next block through the relationship B=B+1.

After the process according to the invention as illustrated in FIG. 2a has been implemented, estimated phase parameters are of course available for each observation datum yₖ of rank k, the phase parameters being referred to as \hat{φ}ₖ and the estimated gain parameters being referred to as Ĝₖ for k belonging to [0,K]. The blocks are of course deemed to include K+1 observation data.

More specifically, it is pointed out that the adaptive process implemented in stage B preferably comprises an iterative function of estimating the estimated phase or gain respectively for each observation datum yₖ of rank k in relation to all the symbols for the QAM modulation considered, having regard to the likelihood probabilities expressed in terms of the log-likelihood for each observation datum yₖ in relation to the set of bits constituting the symbols.

Thus with reference to FIG. 2b, the initialization stage consists of initializing the adaptive process and the iterative function of estimating the phase or gain respectively by verifying the relationship:
AEφ:φₖ=φₖ₋₁+CArgₖ(Imₖ,Wⱼ)
AEG:Gₖ=Gₖ₋₁+CMₖ(Reₖ,Wⱼ).

Stage B2 in FIG. 2b then of course consists of executing the adaptive process and in particular the iterative function of estimating the phase or gain respectively for each observation datum yₖ of rank k in relation to all the symbols for the QAM modulation considered.

In general, with reference to FIG. 2b, it is pointed out that the iterative function for phase estimation which makes it possible to define the adaptive process considered satisfies the abovementioned relationship AEφ. It comprises:
an estimated phase argument term comprising the estimated phase φₖ₋₁ for the preceding observation datum yₖ₋₁ of rank k−1,
a correcting phase argument term denoted CArgₖ(Imₖ,Wⱼ), this corrective phase argument term, in accordance with a noteworthy aspect of the process according to the invention, being proportional to the phase argument value measured for the current observation datum yₖ weighted by the weighting or confidence value expressed in terms of the probability for that current observation datum in relation to the set of symbols for the QAM modulation considered.

The value of the corrective phase argument term CArgₖ(Imₖ,Wⱼ) for the observation datum is taken to be equal to the imaginary part of the complex number produced from the current observation datum yₖ of rank k and the conjugate symbol Q̅j̅ of symbol Qⱼ corrected by the phase argument φₖ₋₁ estimated for the preceding observation datum yₖ₋₁.

Having regard to the above considerations and the specific value of the corrective phase argument term described previously, the iterative function for estimating the phase of each observation datum satisfies the relationship:

$${φ}_{k} = {φ}_{k - 1} + γ \frac{{\sum }_{j = 1}^{M} Im ( {y}_{k} \overline{{Q}_{j}} {ⅇ}^{- ⅈφ k - 1} ) {W}_{j} ( {y}_{k} , {L}^{k} , {φ}_{k - 1} )}{{\sum }_{j = 1}^{M} {W}_{j} ( {y}_{k} , {L}^{k} , {φ}_{k - 1} )} \qquad ( 5 )$$

In the above relationship:

γ designates the predetermined filtering function previously defined in the description,

Im(yₖ Q̅ⱼ̅e^{-iφk-1}) indicates the imaginary part of the complex number produced by observation datum yₖ of rank k and the conjugate symbol Q̅j̅ for the symbol Qⱼ corrected by the phase argument φₖ₋₁ estimated in the previous iteration, that is to say the preceding observation datum yₖ₋₁,

Wⱼ(yₖ,L^{k},φₖ₋₁) indicates the weighting or confidence value expressed in likelihood probability terms attributed to the symbol Qⱼ with regard to the current observation datum yₖ.

As far as the adaptive process for estimating gain is concerned, it is pointed out that the iterative function AEG comprises:
an estimated gain term Gₖ₋₁ for the preceding observation datum yₖ₋₁,
a gain element corrective term CMₖ(Reₖ,Wⱼ) proportional to the value of the difference in gain relating to the current observation datum yₖ of rank k and the estimated gain Gₖ₋₁ for the preceding observation datum, in relation to a given symbol Qⱼ of rank j, this difference value being weighted by the weighting or confidence value expressed in terms of likelihood attributed to the symbol Qⱼ in relation to the set of symbols,
the value of the relative gain difference for the current observation value yₖ of rank k and the estimated gain Gₖ₋₁ for the preceding observation datum in relation to a given symbol Qⱼ of rank j is taken to be equal to the difference between the real part of the scalar product of the current observation datum yₖ and the conjugate symbol Q̅j̅ of the symbol Qⱼ of rank j and the product of the gain Gₖ₋₁ for the preceding observation datum and the square of the modulus of the symbol Qⱼ of rank j. More specifically, it is pointed out that this gain difference value represents a gain correction for the current observation datum with regard to the estimated gain for the preceding observation datum yₖ₋₁ of rank k−1,

Having regard to the comments on the functional definition of the aforesaid corrective gain term, the iterative function AEG satisfies the relationship:

$${G}_{k} = {G}_{k - 1} + γ \frac{{\sum }_{j = 1}^{M} ( Re ( {y}_{k} \overline{{Q}_{j}} ) - {G}_{k - 1} {\vert {Q}_{j} \vert}^{2} ) {W}_{j} ( {y}_{k} , {L}^{k} , {G}_{k - 1} )}{{\sum }_{j = 1}^{M} {W}_{j} ( {y}_{k} , {L}^{k} , {G}_{k - 1} )} \qquad ( 6 )$$

In the above relationship it is pointed out that:

γ indicates the predetermined filtering function,

Re(yₖ Q̅ⱼ̅) indicates the real part of the complex number produced by observation datum yₖ of rank k and conjugate symbol Q̅ⱼ̅ for symbol Qⱼ,

Wⱼ(yₖ,L^{k},Gₖ₋₁) designates the weighting or confidence value expressed in likelihood terms attributed to symbol Qⱼ in relation to current observation datum yₖ.

Of course the weighting value or confidence value expressed in terms of the likelihood attributed to the symbol Qⱼ in respect of observation datum yₖ naturally depends on the estimated phase when the iterative function is implemented for estimating phase, and, on the contrary, the estimated gain when the iterative function of the adaptive processes is implemented for estimating gain.

For an estimate of the phase, the weighting or confidence value expressed in probability terms attributed to the symbol Qⱼ with regard to current observation datum yₖ satisfies the relationship:

$$Wj ( {y}_{n} , {L}^{n} , θ ) = exp ( \frac{1}{2} {\sum }_{m = 1}^{N} {q}_{m}^{j} {L}_{m}^{n} - \frac{{\vert {y}_{n} - {ⅇ}^{+ ⅈθ} {Q}_{j} \vert}^{2}}{{σ}_{b}^{2}} ) \qquad ( 7 )$$

In the above relationship:

exp indicates the exponential function,

qₘ^{j} indicates the m^{th} bit of symbol Qⱼ considered in the QAM modulation used,

Lₘⁿ indicates the log-likelihood value for the current observation datum for m^{th} bit of the n^{th} QAM symbol for a modulation with N+1 symbols,

Lⁿ indicates the list of log-likelihood values for all the bits, with Ln=(L₁ⁿ, . . . L_{N}ⁿ),

σ_{b}² indicates the power of the noise for the transmission channel in question,

θ indicates the phase argument estimated for the observation datum in question.

Likewise, when estimating gain, the weighting or confidence value expressed in likelihood terms attributed to symbol Qⱼ with respect to the observation datum considered satisfies the relationship:

$${W}_{j} ( {y}_{n} , {L}^{n} , G ) = exp ( \frac{1}{2} {\sum }_{m = 1}^{N} {q}_{m}^{j} {L}_{m}^{n} - \frac{{\vert {y}_{n} - {GQ}_{j} \vert}^{2}}{{σ}_{b}^{2}} ) \qquad ( 8 )$$

In the above relationship, the same parameters indicate the same parameters as in relationship (7), except for parameter G, which designates the estimated gain value for the observation datum yₙ considered.

In addition to this, the value of the abovementioned weighting or confidence value introduced through relationships (7) and (8) above is not limiting. In fact the value of the weighting or confidence value expressed in terms of probability attributed to the symbol Qj in relation to yₖ may advantageously correspond to an overall value for each symbol provided per symbol by the soft demapper or turbo-decoder.

In this variant the weighting or confidence value expressed in terms of likelihood attributed to symbol Qj with regard to yₖ satisfies the relationship for phase:

$${W}_{j} ( {y}_{n} , {L}^{n} , θ ) = exp ( {L}_{n , j} - \frac{{\vert {y}_{n} - {ⅇ}^{+ ⅈθ} {Q}_{j} \vert}^{2}}{{σ}_{b}^{2}} ) \qquad ( 7 b )$$

for gain:

$${W}_{j} ( {y}_{n} , {L}^{n} , G ) = exp ( {L}_{n , j} - \frac{{\vert {y}_{n} - {GQ}_{j} \vert}^{2}}{{σ}_{b}^{2}} ) \qquad ( 8 b )$$

In the above relationships Lₙⱼ indicates the likelihood ratio

$$ln \frac{P ( {a}_{j} )}{P ( ref )}$$

provided per symbol by the soft demapper or turbo-decoder, In indicating the Napieran logarithm, P(aⱼ) indicating the probability of the complex symbol aⱼ and P(ref) the probability of a reference value.

Different modes of implementing the process of estimating phase and/or gain to which this invention relates will now be described by way of examples in association with FIG. 3a and subsequent figures.

FIG. 3a relates to a first non-limiting example in which the process to which the invention relates can be used to perform an estimate of the phase parameter only which is suitable for every type of QAM modulation in particular.

With reference to abovementioned FIG. 3a, the process first of all consists of placing observation data yₖ in memory as blocks and executing stage A illustrated in FIG. 2a. It will not be forgotten that this stage consists of performing an iterative estimation of the phase parameters on the basis of a specific phase relationship linking the estimated phase for successive observation data in the sequence. It will not be forgotten that this stage of placing in memory may consist of storing K+1 observations y₀ to y_{K} on the basis of the output signal produced by the complex demodulator or the output from another constituent component of a receiver fitted with a turbo-decoding module. In the applications previously mentioned in the description, the process to which the invention relates may advantageously be applied to blocks of 200 to 2000 observation data, the number of observation data comprising each block being selected in relation to the application and the type of QAM modulation used for transmission of the observation data.

Once these have been placed in memory as aforesaid, stage A in FIG. 2a is then executed on a predetermined sequence of observation data in the block of observation data in question which have been placed in memory. In particular, it is possible to construct any sequence at the outset, such as, for example, a chronological sequence of observation data yₖ in, for example, the order in which the data are received. The function used for implementing the aforesaid iterative estimation may be that previously described in the description for implementing stage A in FIG. 2a.

With reference to FIG. 3a, stage o is then followed by a stage b₁ which comprises initializing a first adaptive process, denoted AEφ₁, so as to fix the first values of the first aforesaid adaptive iterative process starting with a value such as the last estimated phase value.

Initialization stage b₁ is then followed by a stage b₂ which consists of executing the first adaptive process AEφ₁, this adaptive process comprising at least one function of estimating phase parameters depending upon the likelihood value, expressed in terms of the log-likelihood for each observation datum, in relation to all the constituent bits of the symbols in the QAM modulation constellation used.

It will thus be understood that the likelihood value, or soft information, constitutes an external variable through which the process may be rendered adaptive in accordance with the definition previously given in the description. This first aforesaid adaptive process is thus capable of generating a first suite of successive intermediate estimated out-of-phase error values φ₀ to φ_{N} by reading the observation data yₖ of rank k, for example in a forward direction.

The initialization carried out in stage b₁ makes it possible to fix the first values for the first adaptive process. Preferably, when the parameter which has to be estimated has continuity from one observation data block to another, in particular in the case of phase, the first adaptive process is advantageously initialized by considering the last estimated value for the preceding block, for example. It will be understood in particular that for ordinary transmission channels the phase parameter is a parameter which varies slowly because of the stability of transmission during the period corresponding to the transmission of a block of observation data.

Execution of the first aforesaid adaptive process in stage b₂ makes it possible to construct a sequence of estimated phase values φ₀ . . . φₖ, . . . φ_{K}, as shown in FIG. 3c by the top arrow, from left to right.

Following stage b₂ the process to which the invention relates consists of executing a stage b₃ consisting of initializing a second adaptive process AEφ₂ in such a way as to fix the first value of the latter from the last intermediate estimated out-of-phase error value obtained following execution of the first adaptive process AEφ₁.

Preferably, the first value of the second adaptive process AEφ₂ is initialized, namely φ′_{K}, with the last numerical value φ_{K} calculated by the first adaptive process AEφ₁. This operation is shown in FIG. 3c by the bottom arrow from right to left.

Stage b₃ is then followed by stage b₄ consisting of executing the second adaptive process, which of course includes a function for estimating phase parameters dependent on the likelihood value expressed in terms of log-likelihood for each observation datum in relation to the set of bits constituting the symbols. The second adaptive process AEφ₂ makes it possible to create a second suite of estimated successive intermediate out-of-phase error values φ′^{K-1} to φ′₀.

The process to which the invention relates then consists of calculating, in a stage b₅, the final value for the estimated out-of-phase error φ″ₖ for each observation datum yₖ of rank k as a combination of the first and second intermediate out-of-phase error value of the same rank k according to the relationship:
φ″ₖ=g(φₖ,φ′ₖ). (9)

In general, it is pointed out that the relationship combining the first and the second suite of successive intermediate out-of-phase error values is a function selected in relation to the type of QAM modulation considered.

In a particular embodiment, g is selected in such a way as to express the final estimated out-of-phase error value in the form of a linear combination of the first and second suite of successive estimated intermediate out-of-phase error values, for example.

One particular choice might consist of choosing linear combination coefficients Aₖ=Bₖ=½, the linear combination being then of the form
φ″ₖ=Aₖφₖ+Bₖφ′ₖ. (10)

Furthermore, the linear combination coefficients Aₖ and Bₖ may be variable coefficients so as to favour one of the two adaptive processes on the basis of the rank k of the observation data. It is thus possible to choose the weighting for the linear combination in such a way as to favour the first adaptive process AEφ₁ in the right had part of the block illustrated in FIG. 3c and conversely to give more weighting to the second adaptive process in the part of the block in question which is further to the left. This method of working makes it possible to favour the adaptive process which has performed most iterations at all times, and makes it possible to claim greater accuracy when calculating the phase.

As far as implementation of first and second adaptive processes AEφ₁ and AEφ₂ respectively is concerned, it is pointed out that the latter may be used in a particularly advantageous manner through the intermediary of a first and a second phase loop respectively satisfying relationship 11:

$${φ}_{k} = {φ}_{k + ɛ} + γ \frac{{\sum }_{j = 1}^{M} Im ( {y}_{k} \overline{{Q}_{j}} {ⅇ}^{- ⅈφ k + ɛ} ) {W}_{j} ( {y}_{k} , {L}^{k} , {φ}_{k + ɛ} )}{{\sum }_{j = 1}^{M} {W}_{j} ( {y}_{k} , {L}^{k} , {φ}_{K + ɛ} )} . \qquad ( 11 )$$

In particular, with reference to the aforesaid relationship, it is indicated that the first adaptive process is used with ε=−1 in the aforesaid relationship and the second adaptive process is used with ε=+1.

When implementing the aforesaid first and second phase loops, executing the first and the second adaptive processes respectively in succession, expression of the weighting or confidence value expressed in terms of the log-likelihood attributed to symbol Qⱼ with regard to the observation datum considered yₖ satisfies relationship 7 given previously in the description.

The process for estimating phase to which this invention relates in its mode of implementation as illustrated in FIG. 3a is suitable for all types of modulation of the QAM type and utilizes the information as such, soft information for the symbols being provided by, for example, a turbo-decoder.

It should be noted in practice that parameter γ which occurs in the expression for the adaptive function representing the phase loop may comprise a digital filtering function applied to the phase argument or the gain element respectively in order to form the phase or gain argument corrective term on the basis of the out-of-phase error model which it is desired to correct. For simple out-of-phase errors it is possible to manage with a simple proportional corrector, whereas in more complex cases advantageous use can be made of an integral corrector, or a higher order filter. Preferably filtering function γ may be implemented by means of a digital filter of order 2 satisfying relationship 12:

$$γ [ z ] = {γ}_{1} + \frac{{γ}_{2}}{1 - {z}^{- 1}} . \qquad ( 12 )$$

In the above relationship z indicates the transform into Z.

A second example of implementing the process according to the invention to estimate only the gain of a receiver receiving observation data yₖ, this receiver being for example provided with an automatic gain control loop, will now be given in connection with FIG. 3b.

As a general rule, for QAM type modulation, it is also necessary to estimate the channel gain in order to be able to proceed with correct demapping of the QAM symbol at the receiver.

In this situation it is assumed that the observation datum received yₖ is associated with symbol aₖ by relationship 13 below:
yₖ=Gaₖ+bₖ,kε[0,K]. (13)

In the above relationship, aₖ designates the symbols of the QAM constellation used and G indicates a gain, more frequently an attenuation, provided by the transmission channel.

As in the case of estimating phase alone in the embodiment described in relation to FIG. 3a, the embodiment relating to estimate of gain alone comprises using stage o of placing observation data blocks yₖ in memory and stage A in FIG. 2a.

In the case of implementing stage A in FIG. 2a, use is of course made of the iterative function of the specific gain relationship relating the estimated gain for the successive observation data in the sequence of aforesaid observation data.

Following stage o, the process according to the invention for estimating the gain parameter only then consists of calling a stage c₁ which comprises initializing a first adaptive process to fix the first values of the first adaptive process, such as the last estimated gain value. The first adaptive process is denoted AEG₁ in FIG. 3b. The aforesaid initialization may be performed under conditions similar to those carried out when implementing the process for estimating phase alone, in particular as regards the use of digital filtering for calculating factor γ in relation to the normal models for temporal change in the amplitude of observation data yₖ which it is desired to correct. In the same way as in the case of estimating phase alone, a simple proportional corrector may be used for simple models whereas in more complex situations an integral corrector or a filter of higher order may advantageously be used. Initialization of the adaptive process of estimating gain comprises providing the first gain value G₀, and filter γ may be provided by means of a digital filter of order 2 as described previously in the example of implementing the process according to the invention for estimating phase alone.

Abovementioned stage c₁ is then followed by a stage c₂ consisting of executing first adaptive process AEG₁ which of course comprises at least one function for estimating gain parameters which is dependent on the likelihood value, expressed in terms of log-likelihood, for each observation datum with regard to the set of constituent bits of the symbols of the QAM modulation constellation considered. Execution of the first adaptive process AEG₁ makes it possible to produce a first suite of successive intermediate gain values denoted G₀ to G_{K} by reading observation data yₖ of rank k in a forward direction for example as illustrated in association with FIG. 3c.

In a manner similar to the first example for estimating phase only, the process according to the invention for estimating gain only then consists of, in a stage c₃, initializing a second adaptive process referred to as AEG₂ in such a way as to fix the first values of the second adaptive process on the basis of the last estimated gain value G_{K} obtained after executing the first adaptive process.

The aforesaid initialization stage is then followed by a stage c₄ consisting of executing the second adaptive process AEG₂ which of course comprises at least one function for estimating gain parameters which depends on the likelihood value, expressed in terms of log-likelihood, for each observation datum with regard to the set of constituent bits of the symbols for the QAM modulation considered.

Execution of the second adaptive process AEG2 makes it possible to produce a second suite of successive intermediate gain values denoted G′_{K-1} to G′₀ by reading observation data yₖ of rank k in the reverse or retrograde direction.

In a manner similar to the embodiment of the process according to the invention for estimating phase only, a stage c5 is then called to calculate the final estimated gain value G″ₖ for every observation datum yₖ of rank k, this final gain value being expressed as a combination of the first and second intermediate gain values of same rank k according to relationship 14:
G″ₖ=g(Gₖ,G′k). (14)

Of course, stage c₆ makes it possible to perform end of block processing, and the processing may be repeated for each block by the return B=B+1 in the same way as in the situation in FIG. 3a.

In a similar way to the process for estimating phase only, the process according to the invention in the example of estimating gain only is advantageously implemented to execute the first and second adaptive processes AEG₁, AEG₂ through the intermediary of a first and a second gain loop respectively satisfying relationship 15:

$${G}_{k} = {G}_{k + ɛ} + γ \frac{{\sum }_{j = 1}^{M} ( Re ( {y}_{k} \overline{{Q}_{j}} ) - {G}_{k + ɛ} {\vert {Q}_{j} \vert}^{2} ) {W}_{j} ( {y}_{k} , {L}^{k} , {G}_{k + ɛ} )}{{\sum }_{j = 1}^{M} {W}_{j} ( {y}_{k} , {L}^{k} , {G}_{k + ɛ} )} . \qquad ( 15 )$$

In the above relationship ε takes the value −1 for implementing the first adaptive process AEG₁ and E=+1 for implementing the second adaptive process AEG₂.

With reference to the first and second examples of non-restrictive implementation of the processes for estimating phase and gain respectively to which this invention relates it is pointed out that the perfect symmetry of the phase and gain parameters in the relationships which make it possible to execute the process according to the invention is associated with the independent nature of the phase and/or gain variables governing the expression of the phase and gain values respectively in the representative functions of the aforesaid adaptive processes.

In order to implement embodiments estimating phase only or gain only in accordance with FIGS. 3a and 3b mentioned above, it is however pointed out that it is desirable to have a fairly accurate knowledge of the other parameter, that is to say the gain with respect to the phase and vice versa.

In reality, the problem relating to knowledge of one or other of the aforesaid parameters, which in fact mutually exist simultaneously, is that each estimate must normally be based on the results of the other. In the situation where one of the parameters has not been correctly estimated, there is then an unavoidable risk of propagating error.

A third example of implementing the process according to the invention makes it possible to overcome the abovementioned error propagation risks under the conditions below, this third example of implementation comprising estimating these two parameters jointly.

The process used for estimating phase and gain in relation to the subject matter of this invention by joint estimation is now described in association with FIG. 4a.

With reference to aforesaid FIG. 4a the process according to the invention consists of performing a stage o′ comprising an iterative estimation of the gain and/or phase parameters on the basis of a sequence of observation data yₖ. This iterative estimation is performed using a gain-phase loop and can be used to estimate the gain phase of each observation datum in relation to the symbols for the QAM modulation in question.

In particular it will be understood that aforesaid stage o′ of course comprises the placing of a block of observation data yₖ in memory accompanied executing a stage referred to as a′, substantially corresponding to stage A in FIG. 2a. In particular stage A′ may correspond to execution of the iterative function referred to in stage A and the iterative function relating to gain referred to by that same stage.

In order to implement stage A′, and in accordance with a preferred non-restrictive embodiment, use of two separate iterative phase and gain functions respectively may be advantageously replaced by calling an adaptive phase or gain process respectively in which the value of L^{k}, the list of the log-likelihood values for all the bits, is arbitrarily taken to be equal to 0. Under these conditions the adaptive process for estimating gain and phase respectively is then implemented with respect to each symbol, each of the symbols for the QAM modulation being considered to be equally likely. This assumption is sufficient to ensure an acceptable degree of accuracy for the initialization stage alone.

Following aforesaid stage o′, the process for joint estimation of the gain and phase parameters to which the invention relates, as illustrated in FIG. 4a, consists of calling a stage d1 which comprises initializing a first adaptive process so as to fix the first estimated gain value G₀ and phase value φ₀.

In order to implement joint estimation of gain and phase respectively, it is pointed out that the process according to the invention comprises processing observation data yₖ satisfying relationship 16:
yₖ=aₖGe^{iθk}+bₖ for kε[0,K]. (16)

In this relationship aₖ indicates the QAM symbols, G indicates a parasitic gain provided by the transmission channel, for example, and θk indicates the parasitic out-of-phase error which has to be processed. In particular it will be understood that stage d1 can be used to initialize and fix the first estimated gain value G₀ and phase value φ₀ in order to implement the first adaptive process referred to as AEGφ₁.

The abovementioned initialization stage is followed by a stage d₂ consisting of executing the first adaptive process AEGφ₁ and comprises at least one function of estimating gain and phase parameters which are dependent on the likelihood probability, expressed in terms of log-likelihood, of each observation datum with regard to the set of constituent bits for the symbols of the QAM modulation considered.

Execution of the first adaptive process AEGφ₁ makes it possible to produce a first suite of successive intermediate values for gain G₀ to G_{K} and φ₀ to φ_{K} respectively.

Stage d₂ is followed by a stage d₃ which consists of initializing a second adaptive gain and phase process AEGφ₂ in such a way as to fix the first values for the second adaptive process on the basis of the last estimated gain and phase values obtained respectively following execution of the first adaptive process AEGφ₁.

Second adaptive process AEGφ₂ is then executed, this adaptive process comprising at least one function of estimating gain and phase parameters respectively which depend on the likelihood probability value, expressed in terms of log-likelihood, of each observation datum in relation to the set of constituent bits of the QAM modulation symbols.

Execution of the second adaptive process AEGφ₂ makes it possible to produce a second suite of successive intermediate gain and phase values G′_{K-1} to G′₀ and φ′_{K-1} to φ′₀ by reading observation data yₖ of rank k in the reverse or retrograde direction.

Abovementioned stage d4 is then followed by stage d5 which consists of calculating the final gain and phase value respectively for each observation datum yₖ of rank k as a combination of the first and second intermediate gain and phase values respectively of the same rank k according to relationship 17:
G″ₖ=g(Gₖ,G′ₖ). (17)
φ″ₖ=g(φₖ,φ′ₖ).

In the above relationship g indicates a specific function.

In order to implement a joint estimation of phase and gain as described in connection with FIG. 4 it is pointed out that the first and second adaptive processes AEGφ₁ and AEGφ₂ are implemented using a gain-phase loop satisfying relationships 18, 19:

$$\begin{matrix}{φ}_{k} = {φ}_{k + ɛ} + {γ}_{1} \frac{{\sum }_{j = 1}^{M} Im ( {y}_{k} \overline{{Q}_{j}} ) {G}_{k + ɛ} {ⅇ}^{- ⅈφ k + ɛ} ) {W}_{j} ( {y}_{k} , {L}^{k} , {φ}_{k + ɛ} , {G}_{k + ɛ} )}{{\sum }_{j = 1}^{M} {W}_{j} ( {y}_{k} , {L}^{k} , {φ}_{k + ɛ} , {G}_{k + ɛ} )} & ( 18 ) \\ {G}_{k} = {G}_{k + ɛ} + {γ}_{2} \frac{{\sum }_{j = 1}^{M} ( Re ( {y}_{k} \overline{{Q}_{j}} {ⅇ}^{- ⅈφ k + ɛ} ) - {G}_{k + ɛ} {\vert {Q}_{j} \vert}^{2} ) {W}_{j} ( {y}_{k} , {L}^{k} , {φ}_{k + ɛ} , {G}_{k + ɛ} )}{{\sum }_{j = 1}^{M} {W}_{j} ( {y}_{k} , {L}^{k} , {φ}_{k + ɛ} , {G}_{k + ɛ} )} & ( 19 )\end{matrix}$$

In the above relationships it will not be forgotten that, as in the case when implementing estimation of phase or gain alone respectively, parameter ε is taken to be equal to −1 for first adaptive process AEGφ₁ but is taken to be equal to the value +1 for second adaptive process AEGφ₂.

Furthermore parameters γ1 and γ2 indicate a specific filtering function selected in relation to the type of QAM modulation. The choice may be made in a way comparable to that indicated for the choice of parameter γ in the example of implementing estimation of phase alone or gain alone respectively.

In order to implement a joint estimation of phase and gain the weighting or confidence value expressed in terms of the log-likelihood attributed to symbol Qj in relation to the observation datum must also be calculated jointly for the phase and gain parameters.

On this assumption the abovementioned weighting or confidence value satisfies relationship (20):

$${W}_{j} ( {y}_{n} , {L}^{n} , θ , G ) = exp ( \frac{1}{2} {\sum }_{m = 1}^{N} {q}_{m}^{j} {L}_{m}^{n} - \frac{{\vert {y}_{n} - {Ge}^{+ ⅈ θ} {Q}_{j} \vert}^{2}}{{σ}_{b}^{2}} ) \qquad ( 20 )$$

In the aforesaid relationship G indicates the estimated gain and θ indicates the estimated phase for observation data yₙ in question and Lⁿ designates

In all the situations in which the process according to the invention illustrated in FIGS. 3a, 3b and 4a is implemented, the stages of executing adaptive process b2, b4; c2, c4 and d2, d4 may be repeated for a number of iterations b′2, b′4, c′2, c′4 and d′2, d′4 symbolized by loops R=R+1, R′=R′+1 in order to improve the accuracy of the calculations, the number of iterations reaching 3 and 4.

A gain phase loop according to this invention will now be described in association with FIG. 4b.

The abovementioned gain phase loop comprises a summator 40 receiving at its summation inputs the phase parameter φ_{k+ε} and the gain parameter G_{k+ε} estimated for the preceding observation datum and the phase correction term CArgₖ(Iₘ,Wⱼ) respectively for the gain CMₖ(Rₑₖ,Wⱼ) and produces the phase parameter γₖ and/or the gain parameter Gₖ estimated for the current observation datum γₖ of rank k. A functional modulus 42 of the argument of phase F and gain G respectively is provided, which, on receiving current observation datum yₖ of rank k, phase and gain parameters φ_{k+ε}, G_{k+ε} estimated for the previous observation datum, symbols Q1 to QM from the alphabet of QAM symbols and the list of log-likelihood values for all bits L^{k}, provides a phase and/or gain argument. A filter 42 γ1,γ2 applied to the phase and/or gain argument delivers the phase and/or gain correction term to summator 40. The phase loop shown in FIG. 4b may comprise a software module or a dedicated calculator.

The process according to the invention, in particular when implemented for jointly estimating phase and gain may advantageously be implemented in the case of single carrier and multicarrier transmissions.

It will be understood in particular that because of the level of accuracy achieved, particularly in the case of implementing a joint estimate of phase and gain, this process can be applied to a large range of frequencies, in particular in the case of multicarrier transmission. It will be seen in fact that the variability of the transmission channel, which depends on the transmission frequency, is not the same in relation to the carrier frequency. The flexibility of implementing the process according to this invention in this situation appears particularly attractive because of the accuracy of the results obtained, regardless of the variability of the transmission channel and multicarrier transmission conditions.

In particular, in the case of multicarrier transmission, the process according to the invention may be implemented independently on a smaller number of sub-carriers forming the multicarrier system, it being understood that the concept of independence ultimately amounts to qualifying the parameters, such as filtering parameters γ, for example, on the basis of the sub-carrier frequency value.

Furthermore, in this situation the process according to the invention may advantageously comprise interpolating gain and/or phase values for the other subcarriers of the multicarrier system in relation to the frequency values of the subcarriers considered. It will of course be understood that in this way the gain and/or phase values can be adjusted in order to achieve optimum accuracy.

The process of joint estimation of the gain in phase according to this invention as described in FIG. 4a can of course be implemented in a receiver system, a receiver such as that illustrated in FIG. 5a, at the output from the complex demodulator of the latter providing observation data yₖ.

With regard to the aforesaid receiver, at the output from the complex demodulator, which is not shown in the drawing in FIG. 5a, the latter comprises the gain and phase processing module 1 through which the estimated out-of-phase error value φₖ for observation datum yₖ of rank k can be applied, together with the estimated gain value Gₖ. The estimated gain value Gₖ must be understood as being applied in the receiver's automatic gain control loop. Module 1 for gain and phase processing is then followed by a flexible demapper 2 which is itself followed by a turbo-decoder 3. Turbo-decoder 3 then provides flexible information, that is to say L^{k} designating the list of log-likelihood values for all the bits, through which the weighting or confidence value expressed in terms of the log-likelihood attributed to the symbol Qⱼ can be calculated with respect to the observation data. This weighting or confidence value is provided for phase and gain values respectively in accordance with relationships 7 and 8, which have been previously mentioned in the description. The aforesaid L^{k} values are then delivered to a gain-phase loop implementing the AEGφ function and the iterative process, the gain-phase loop which is identified by reference 4 and delivering the estimated phase and gain parameters φₖ and Gₖ respectively for observation datum yₖ in question to gain and phase processing module 1.

Of course in order to implement the process according to the invention on the basis of joint detection of the phase and gain respectively, for initializing stage o′ the iterative initialization procedure is implemented through the intermediary of module 4 in which L^{k}=0 is set regardless of k, module 4 then providing the initialization values from a merely iterative procedure denoted AEGφ(L^{k}=0) and the procedure for initializing and executing the two adaptive processes AEGφ₁ and AEGφ₂ respectively then being performed.

As far as amplitude and phase processing module 1, flexible demapper 2 and turbo-decoder 3 are concerned, these modules will not be described in detail, as they are equivalent to elements known in the art.

Gain-phase loop module 4 is a digital processing module comprising functions implementing the gain-phase loop satisfying relationships 18, 19 and 20 previously given in the description, as described in association with FIG. 4b.

Finally, as illustrated in FIG. 5b, when the QAM symbols are transmitted with the interleaving of transmitted bit sequences giving rise to interleaving of the QAM symbols emitted, the receiver according to the invention comprises a de-interleaver module 3a located upstream from turbo-decoder 3 and an interleaver module 3b located at the output from turbo-decoder 3, that is to say upstream of gain-phase loop 4.

The operating procedure for the abovementioned interleavers and interleaver module will not be described in detail it is equivalent to a procedure known in the art. It can be used to disambiguate qπ/2 with q integer, for the observation data and finally the symbols emitted.

1. A method for estimating the phase and/or gain parameters of observation data placed in memory corresponding to a succession of digital symbols formed by a suite of bits in QAM modulation transmitted by a transmission channel, characterized in that it comprises the steps consisting of:
a) making an iterative estimate of the said phase and/or gain parameters based on a sequence of observation data, the said iterative estimate being obtained using a specific phase and/or gain relationship linking the estimated phase of the successive observation data in the said sequence,
b) initializing at least one adaptive procedure for estimating the said phase and/or gain parameters on the basis of at least one of the successive estimated phase and/or gain values for the said observation data and executing the said adaptive estimation process comprising at least one function of estimating the said phase and/or gain parameters depending upon the likelihood probability value expressed in terms of log-likelihood of each observation datum with regard to the set of constituent bits of the said symbols.

2. A method according to claim 1, characterized in that the said specific phase and/or gain relationship satisfies the relationship:
φₖ=φₖ₋₁+γF(yₖ,φₖ₋₁);Gₖ=Gₖ₋₁+γG(yₖ,Gₖ₋₁).
Wherein:
φₖ, φₖ₋₁ indicate the value of the estimated phase of observation datum yₖ and yₖ₋₁ respectively of rank k and k−1 respectively,
Gₖ and Gₖ₋₁ indicate the estimated gain value for the observation datum yₖ and yₖ₋₁ respectively of rank k and k−1 respectively,
F and G respectively indicate a specific function which depends on the type of QAM modulation used,
γ indicates a predetermined filtering function.

3. A method according to claim 1, characterized in that the said adaptive method comprises an iterative function for estimating the estimated phase and gain respectively of each observation datum yₖ of rank k with respect to all the symbols of the QAM modulation in question, having regard to the likelihood probability expressed in terms of log-likelihood each observation datum with regard to the set of bits constituting the symbols.

4. A method according to claim 3, characterized in that the said iterative function for estimating the phase of each observation datum satisfies the relationship:
$${φ}_{k} = {φ}_{k - 1} + γ \frac{{\sum }_{j = 1}^{M} Im ( {y}_{k} \overline{{Q}_{j}} {ⅇ}^{- ⅈφ k - 1} ) {W}_{j} ( {y}_{k} , {L}^{k} , {φ}_{k - 1} )}{{\sum }_{j = 1}^{M} {W}_{j} ( {y}_{k} , {L}^{k} , {φ}_{k - 1} )}$$
in which relationship:
γ indicates the predetermined filtering function previously defined in the description,
Im(yₖ Q̅ⱼ̅e^{-iφk-1}) indicates the imaginary part of the complex number produced by observation datum yₖ of rank k and the conjugate symbol Q̅j̅ for the symbol Qⱼ corrected by the phase argument φₖ₋₁ estimated in the previous iteration, that is to say the preceding observation datum yₖ₋₁,
Wⱼ(yₖ,L^{k},φₖ₋₁) indicates the weighting or confidence value expressed in likelihood probability terms attributed to the symbol Qⱼ with regard to the current observation datum yₖ.

5. A method according to claim 3, characterized in that the said iterative function for estimating the gain of each observation datum satisfies the relationship:
$${G}_{k} = {G}_{k - 1} + γ \frac{{\sum }_{j = 1}^{M} ( Re ( {y}_{k} \overline{{Q}_{j}} ) - {G}_{k - 1} {\vert {Q}_{j} \vert}^{2} ) {W}_{j} ( {y}_{k} , {L}^{k} , {G}_{k - 1} )}{{\sum }_{j = 1}^{M} {W}_{j} ( {y}_{k} , {L}^{k} , {G}_{k - 1} )}$$
in which relationship:
γ indicates the predetermined filtering function,
Re(yₖ Q̅ⱼ̅) indicates the real part of the complex number produced by observation datum yₖ of rank k and conjugate symbol Q̅ⱼ̅ for symbol Qⱼ,
Wⱼ(yₖ,L^{k},Gₖ₋₁) indicates the weighting or confidence value expressed in likelihood terms attributed to symbol Qⱼ in relation to current observation datum yₖ.

6. A method according to claim 1, characterized in that when estimating the phase the weighting or confidence value expressed in terms of the likelihood attributed to symbol Qⱼ with respect to the observation datum satisfies the relationship:
$$Wj ( {y}_{n} , {L}^{n} , θ ) = exp ( \frac{1}{2} {\sum }_{m = 1}^{N} {q}_{m}^{j} {L}_{m}^{n} - \frac{{\vert {y}_{n} - {ⅇ}^{+ ⅈθ} {Q}_{j} \vert}^{2}}{{σ}_{b}^{2}} )$$
in which relationship:
exp indicates the exponential function,
qₘ^{j} indicates the m^{th} bit of symbol Qⱼ considered in the QAM modulation used,
Lₘⁿ indicates the log-likelihood value for the current observation datum for the m^{th} bit of the n^{th} QAM symbol,
Lⁿ designates the list of log-likelihood values for all the bits, with Lⁿ=(L₁ⁿ, . . . L_{N}ⁿ),
σ_{b}² designates the power of the noise for the transmission channel considered,
θ indicates the estimated phase argument.

7. A method according to claim 1, characterized in that when estimating gain the weighting or confidence value expressed in terms of the likelihood attributed to symbol Qⱼ in relation to the observation datum satisfies the relationship:
$${W}_{j} ( {y}_{n} , {L}^{n} , G ) = exp ( \frac{1}{2} {\sum }_{m = 1}^{N} {q}_{m}^{j} {L}_{m}^{n} - \frac{{\vert {y}_{n} - {GQ}_{j} \vert}^{2}}{{σ}_{b}^{2}} )$$
in which relationship:
exp indicates the exponential function,
qₘ^{j} indicates the m^{th} bit of symbol Qⱼ in the QAM modulation,
Lₘⁿ indicates the log-likelihood value for the current observation datum for the m^{th} bit of the n^{th} QAM symbol,
Lⁿ designates the list of log-likelihood values for all the bits, Lⁿ=(L₁ⁿ, . . . L_{N}ⁿ),
σ_{b}² designates the power of the noise for the transmission channel considered,
G indicates the estimated gain value.

8. A method according to claim 1, characterized in that in order to estimate the phase parameter the method consists of, following stage o) performing iterative estimation of the phase parameters on the basis of a specific phase relationship linking the estimated phase of the successive observation data in the said sequence:
b1) initializing a first adaptive process so as to fix the first values of the first adaptive process, such as the last estimated phase value,
b2) executing a first adaptive process comprising at least one function estimating the said phase parameters which depends on the likelihood probability value expressed in terms of the log-likelihood of each observation datum with respect to the set of bits constituting the said symbols in order to produce a first suite of successive intermediate estimated out-of-phase error values φₒ to φ_{K} by reading the observation data yₖ of rank k in a forward direction,
b3) initializing a second adaptive process so as to fix the first values for the second adaptive process on the basis of the last intermediate estimated out-of-phase error value obtained following execution of the first adaptive process,
b4) executing the second adaptive process comprising at least one function estimating the said phase parameters which depends on the likelihood probability expressed in terms of log-likelihood of each observation datum with respect to the suite of bits constituting the said symbols in order to produce a second suite of successive intermediate estimated out-of-phase error values φ′_{K-1} to φ′ₒ by reading the observation data yₖ of rank k in the reverse direction,
b5) calculating the final estimated out-of-phase error value φ″ₖ for all the observation data yₖ of rank k as a combination of the first and second out-of-phase error values for the same rank k using the relationship:
φ″ₖ=g(φₖ,φ′ₖ).

9. A method according to claim 4, characterized in that the first and the second adaptive processes are implemented through the intermediary of a first and a second phase loop respectively satisfying the relationship:
$${φ}_{k} = {φ}_{k + ɛ} + γ \frac{{\sum }_{j = 1}^{M} Im ( {y}_{k} {\overline{Q}}_{j} {ⅇ}^{- ⅈφ k + ɛ} ) {W}_{j} ( {y}_{k} , {L}^{k} , {φ}_{k + ɛ} )}{{\sum }_{j = 1}^{M} {W}_{j} ( {y}_{k} , {L}^{k} , {φ}_{k + ɛ} )}$$
with ε=−1 for the first adaptive process and ε=+1 for the second adaptive process.

10. A method according to claim 5, characterized in that in order to estimate the gain parameter the method consists of, following stage o) comprising performing an iterative estimate of the gain parameters from the specific gain relationship linking the estimated gain for the successive observation data in the said sequence:
c1) initializing a first adaptive process so as to fix the first values for the first adaptive process such as the last estimated gain value,
c2) executing the said first adaptive process comprising at least one function estimating the said gain parameters which depends on the likelihood probability value expressed in terms of log-likelihood of each observation datum with respect to the set of constituent bits of the said symbols in order to produce a first suite of successive intermediate gain values Gₒ to G_{K} by reading observation data yₖ of rank k in a forward direction,
c3) initializing a second adaptive process so as to fix the first values of the second adaptive process on the basis of the last estimated gain value obtained following execution of the first adaptive process,
c4) executing the second adaptive process comprising at least one function estimating the said gain parameters which depends on the likelihood probability expressed in terms of log-likelihood of each observation datum with respect to the set of constituent bits of the said symbols to produce a second suite of successive intermediate gain values G′_{K-1} to G′ₒ by reading observation data yₖ of rank k in the reverse direction,
c5) calculating the final estimated gain value G″ₖ for each observation datum yₖ of rank k as a combination of the first and the second gain value of same rank k in accordance with the relationship:
G″ₖ=g(Gₖ,G′ₖ).

11. A method according to claim 10, characterized in that the first and second adaptive processes are implemented through the intermediary of a first and second gain loop respectively satisfying the relationship:
$${G}_{k} = {G}_{k + ɛ} + γ \frac{{\sum }_{j = 1}^{M} ( Re ( {y}_{k} \overline{{Q}_{j}} ) - {G}_{k + ɛ} {\vert {Q}_{j} \vert}^{2} ) {W}_{j} ( {y}_{k} , {L}^{k} , {G}_{k + ɛ} )}{{\sum }_{j = 1}^{M} {W}_{j} ( {y}_{k} , {L}^{k} , {G}_{k + ɛ} )}$$
with ε=−1 for the first adaptive process and ε=+1 for the second adaptive process.

12. A method according to claim 1, characterized in that for joint estimation of the gain in phase parameters the method consists of:
o′) performing an iterative estimation of the said gain and/or phase parameters from a sequence of observation data, the said iterative estimation being performed using a gain-phase loop, the said iterative estimation stage making it possible to estimate the gain in phase of each observation datum with respect to the QAM modulation symbols.
d1) initializing a first adaptive process so as to fix the first estimated gain and phase values Gₒ and φₒ,
d2) executing the said first adaptive process comprising at least one function estimating the said gain and phase parameters which depends on the likelihood probability expressed in terms of log-likelihood of each observation datum with respect to the set of bits constituting the said symbols to produce a first suite of successive intermediate gain values Gₒ to G_{K} and phase values φₒ to φ_{K} respectively by reading observation data yₖ of rank k in a forward direction,
d3) initializing a second adaptive process so as to fix the first values of the second adaptive process on the basis of the last estimated gain and phase values respectively obtained following execution of the said first adaptive process,
d4) executing the said second adaptive process comprising at least one function for estimating the said gain and phase parameters which depends on the likelihood probability value expressed in terms of log-likelihood of each observation datum with respect to the set of bits constituting the said symbols to produce a second suite of successive intermediate gain values G′_{K-1} to G′ₒ and phase values φ′_{K-1} to φ′ₒ respectively by reading observation data yₖ of rank k in the reverse direction,
d5) calculating the final gain and phase values respectively for each observation datum yₖ of rank k as a combination of the first and the second intermediate gain and phase values respectively of the same rank k in accordance with the relationships:
G″ₖ=g(Gₖ,G′ₖ).
φ″ₖ=g(φₖ,φ′ₖ).
in which relationship g designates a specific function.

13. A method according to claim 12, characterized in that the said first and second adaptive process are implemented using a gain-phase loop satisfying the relationships
$${φ}_{k} = {φ}_{k + ɛ} + {γ}_{1} \frac{{\sum }_{j = 1}^{M} Im ( {y}_{k} \overline{{Q}_{j}} ) {G}_{k + ɛ} {ⅇ}^{- ⅈφ k + ɛ} ) {W}_{j} ( {y}_{k} , {L}^{k} , {φ}_{k + ɛ} , {G}_{k + ɛ} )}{{\sum }_{j = 1}^{M} {W}_{j} ( {y}_{k} , {L}^{k} , {φ}_{k + ɛ} , {G}_{k + ɛ} )}$$
$${G}_{k} = {G}_{k + ɛ} + {γ}_{2} \frac{{\sum }_{j = 1}^{M} ( Re ( {y}_{k} \overline{{Q}_{j}} {ⅇ}^{- ⅈφ k + ɛ} ) - {G}_{k + ɛ} {\vert {Q}_{j} \vert}^{2} ) {W}_{j} ( {y}_{k} , {L}^{k} , {φ}_{k + ɛ} , {G}_{k + ɛ} )}{{\sum }_{j = 1}^{M} {W}_{j} ( {y}_{k} , {L}^{k} , {φ}_{k + ɛ} , {G}_{k + ɛ} )}$$
with ε=−1 for the first adaptive process and ε=+1 for the second adaptive process,
γ₁ and γ₂ designating a specific filtering function selected on the basis of the type of QAM modulation.

14. A method according to claim 12, characterized in that for joint estimation of the gain and phase the weighting or confidence value expressed in terms of the likelihood attributed to Qⱼ with respect to the observation datum satisfies the relationship:
$${W}_{j} ( {y}_{n} , {L}^{n} , θ , G ) = exp ( \frac{1}{2} {\sum }_{m = 1}^{N} {q}_{m}^{j} {L}_{m}^{n} - \frac{{\vert {y}_{n} - {Ge}^{+ ⅈθ} {Q}_{j} \vert}^{2}}{{σ}_{b}^{2}} )$$
in which relationship:
exp indicates the exponential function,
qₘ^{j} indicates the m^{th} bit of symbol Qⱼ in the QAM modulation,
Lₘⁿ indicates the log-likelihood value of the observation datum for the m^{th} bit of the n^{th} QAM symbol,
Lⁿ indicates the list of log-likelihood values for all the bits, Ln=(L₁ⁿ, . . . , L_{N}ⁿ),
σ_{b}² indicates the noise power for the transmission channel in question,
θ indicates the estimated phase argument,
G indicates the estimated gain.

15. A method according to claim 8, characterized in that each stage of executing the adaptive process is repeated for a specific number of iterations.

16. A gain-phase loop for adaptive estimation of the gain and/or phase of a current observation datum with respect to the gain and/or phase of a preceding observation datum with respect to a set of symbols transmitted in QAM modulation via a transmission channel on the basis of the likelihood probability value expressed in terms of the log-likelihood of each observation datum with respect to the set of bits constituting these symbols, characterized in that the said gain-phase loop comprises at least:
summation means receiving at input the phase and gain parameter respectively for the preceding observation datum and a term correcting the gain and gain argument respectively delivering the estimated phase and gain parameter respectively for the current observation datum,
a functional module for the phase and/or gain argument in cascade with a filtering module, the said phase and/or gain functional module receiving the said phase and gain parameters respectively for the preceding observation datum, the said current observation datum and the list of log-likelihood values for all the bits of the observation datum with respect to each symbol of the QAM modulation and delivering a value proportional to the value of the measured phase argument of the current observation datum weighted by the weighting or confidence value of this current observation datum with respect to the set of QAM modulation symbols and respectively a value proportional to the value of the difference in gain between the current observation datum and the estimated gain of the preceding observation datum with respect to a given symbol of the QAM modulation, weighted by the weighting or confidence value expressed in terms of the log-likelihood attributed to the symbol with respect to the set of these symbols to the filtering module, the said filter delivering the said phase argument correcting term and/or gain element to the said summation means.

17. A receiver for digital observation data transmitted in QAM modulation via a transmission channel, characterized in that it comprises, at the input to the complex demodulator, at least in combination, a gain and phase processing module which can be used to apply the estimated out-of-phase error and gain value for the current period of observation, a soft demapper and a turbo-decoder, the said turbo-decoder delivering soft information as a list of the log-likelihood values attributed to the symbol Qⱼ in respect of the observation data, and a gain-phase loop according to claim 16.

18. A receiver according to claim 17, characterized in that for the transmission of observation data with interleaving of the QAM symbols transmitted, the said receiver comprises:
a deinterleaver module located upstream of the turbo-decoder,
an interleaver module located upstream of the said gain-phase loop which can be used to disambiguate the phase in the observation data received.

19. (canceled)

20. Method for estimating phase and/or gain according to claim 1, characterized in that in a multicarrier transmission, wherein
α) the method is used independently on a reduced number of subcarriers constituting the multicarrier system and
β) the gain and/or phase values are interpolated for the other sub-carriers of the multicarrier system according to the frequency values of the sub-carriers in question.

21. A method according to claim 1, characterized in that in order to estimate the gain parameter the method consists of, following stage o) comprising performing an iterative estimate of the gain parameters from the specific gain relationship linking the estimated gain for the successive observation data in the said sequence:
c1) initializing a first adaptive process so as to fix the first values for the first adaptive process such as the last estimated gain value,
c2) executing the said first adaptive process comprising at least one function estimating the said gain parameters which depends on the likelihood probability value expressed in terms of log-likelihood of each observation datum with respect to the set of constituent bits of the said symbols in order to produce a first suite of successive intermediate gain values Gₒ to G_{K} by reading observation data yₖ of rank k in a forward direction,
c3) initializing a second adaptive process so as to fix the first values of the second adaptive process on the basis of the last estimated gain value obtained following execution of the first adaptive process,
c4) executing the second adaptive process comprising at least one function estimating the said gain parameters which depends on the likelihood probability expressed in terms of log-likelihood of each observation datum with respect to the set of constituent bits of the said symbols to produce a second suite of successive intermediate gain values G′_{K-1} to G′ₒ by reading observation data yₖ of rank k in the reverse direction,
c5) calculating the final estimated gain value G″ₖ for each observation datum yₖ of rank k as a combination of the first and the second gain value of same rank k in accordance with the relationship:
G″ₖ=g(Gₖ,G′ₖ).
